(19) United States
(12) Patent Application Publication
(10) Pub. No.: US 2005/0206736 A1
(43) Pub. Date: Sep. 22, 2005

(54) Automatic angle adjusting system

(75) Inventors: Chong-Khai Ng, Penang (MY); Shih-Hsiung Weng, Taipei (TW)

Correspondence Address: Mr. Peter F. Corless;EDWARDS & ANGELL, LLP, 101 Federal Street, Boston, MA, 02110, US

(73) Assignee: Inventec Multimedia & Telecom Corporation

(21) Appl. No.: 10/804,864

(22) Filed: Mar. 19, 2004

(51) Int. Cl. H04N 7/00

(52) U.S. Cl. 348/208.7; 348/208.99; 348/208.4

(57) ABSTRACT

An automatic angle adjusting system for an image capturing device is provided, the image capturing device having an image capturing unit. The automatic angle adjusting system includes a driving device, an angle detector and a controlling device. The angle detector detects the location of the image capturing unit. The controlling device calculates an angle of the location of the image capturing unit deviating from a preset angle, and transmits a signal to the driving device that generates a mechanical driving force to rotate and resume the image capturing unit to the preset angle.

### FIELD OF THE INVENTION

The present invention relates to automatic angle adjusting systems, and more particularly, to an automatic horizontal balancing system employed in an image capturing device for capturing precisely positioned images.

### BACKGROUND OF THE INVENTION

Digital camera, video camera and mobile phone equipped with image capturing device are popular electronic products for recording sweet memories. Digital camera, for example, is an electronic product combining conventional camera and scanner. The theory of digital camera is to apply charge coupled device (CCD) or complementary metal-oxide semiconductor (CMOS) to convert light signals reflected by objects into digital signals, wherein the digital signals are compressed and stored in a built-in random-access memory (RAM) or portable PCMCIA (Personal Computer Memory Card International Association) card. Due to the advantages such as small size, light weight, convenience for carrying and no film development of the digital camera and mobile phone, these image capturing devices gradually replace conventional cameras in the market.

During the course of taking a picture, a user (especially beginner) of the above image capturing device may be difficult to maintain the image capturing device positioned in a proper horizontal angle on the hand, making the captured picture slanted. Further, when taking a motion picture, since the lens of the image capturing device needs to move along the object in motion, the slanted picture in FIG. 1A is usually captured due to vibration or imbalance of the moving image capturing device.

Referring to FIG. 1A, if the image capturing device 100 is positioned with an X angle deviating from the horizontal, the first captured image 101 is slanted by the X angle shown in FIG. 1B. In order to correct the slanted first image 101 to be horizontal, the user should store the first image 101 to a computer, execute the relating image editing software, and select the functions such as “rotate”, “cut” and “crop” to edit the first image 101 to achieve a horizontal second image 102 shown in FIG. 1C.

Although the image capturing device 100 can easily take pictures, in the case of the slanted first image 101 captured, the computer and specific image editing software are required to correct the first image 101 to form the desired second image 102.

Moreover, during editing the slanted first image 101 with the image editing software, unduly complicated steps should be performed to obtain the correct horizontal second image 102, thereby making the editing process complex and time-consuming to implement by the user who is not familiar with the image editing software.

Further, if the “cut” or “crop” function is performed, the cut-off part (such as background) of the picture or image is lost, and only the selected part is stored. Although the saved selected part can be enlarged, it however only shows a proportion of the picture, and the cut-off part can not be regained.

The present applicant is granted with a Taiwanese Utility Model Patent No. 504013 (filed on Aug. 15, 2001 and issued on Sep. 21, 2002) related to an angle-adjustable digital camera. The angle of this digital camera can be adjusted when capturing a static picture. However, it does not solve the problem of picture slanting when moving the digital camera to take a motion picture.

Therefore, the problem to be solved here is to provide an image capturing device, which can eliminate the above prior-art drawbacks to properly take a motion picture without any slanted angle.

### SUMMARY OF THE INVENTION

A primary objective of the present invention is to provide an automatic angle adjusting system for use in an image capturing device, which can automatically adjust an oriented angle of a picture captured by image capturing device to obtain a balanced image.

Another objective of the present invention is to provide an angle adjusting system for use in an image capturing device, which can adjust an image capturing unit of the angle adjusting system to a preset angle to allow the image capturing device to be operated at any angle for capturing a precisely-positioned picture.

In accordance with the above and other objectives, the present invention proposes an automatic angle adjusting system. The automatic angle adjusting system is suitably employed in an image capturing device such as digital camera, video camera, mobile phone or the like, so as to automatically adjust an oriented angle of an image captured by an image capturing unit of the image capturing device. The automatic angle adjusting system comprises: a driving device for providing the image capturing unit with a mechanical driving force; an angle detector for detecting the location of the image capturing unit; and a controlling device for storing the preset angle value and calculating an angle of the location of the image capturing unit deviating from the preset angle, and for transmitting a signal to the driving device that drives the image capturing unit to resume to the preset angle. The driving device comprises a motor and a gear mechanism. The preset angle can be 0° or a slanted angle other than the 0° angle deviating from a horizontal line. The angle detector comprises a conductive pattern board, a tunnel member and at least one conductive element. The controlling device comprise a conversion module, an angle preset module, a comparison calculating module, a compensation calculating module, a motor driving module and a display driving module.

The automatic angle adjusting system can further comprise a display device to receive signals from the controlling device for displaying the shooting status of the image capturing device. The display device or a sound device can receive a display signal or sound signal from the controlling device for generating a caution signal when the image capturing device is adjusted to the preset angle.

The procedure of operating the image capturing device incorporated with the automatic angle adjusting system comprises launching a preset function and a real-time balancing function of the automatic angle adjusting system.

Firstly, the preset function of the automatic angle adjusting system is launched, the image capturing device works according to a default preset angle. In addition, the user can select a preset angle stored in the angle preset module of the controlling device, or input a preset angle via an input interface. The selected or inputted preset angle value is recorded by the controlling device.

Secondly, the real-time balancing function is launched. When the user holds the image capturing device, the conductive element contacts and electrically actuates at least one pair of metal pads of the tunnel member that generate a position signal indicating a position of the actuated metal pads. Following procedures comprise: calculating the slanted angle between the actuated metal pads and the horizontal line; calculating the difference value between the preset angle value and the slanted angle value; calculating the compensation angle value which is a reverse value of the difference value; calculating the rotation direction and rotation turns for the motor according to the compensation angle value; actuating the motor for providing the mechanical driving force and driving the gear mechanism; driving the image capturing unit to rotate to the preset position according to the mechanical driving force; and reminding the user with a text signal or sound signal that the image capturing device is adjusted to the preset position.

The automatic angle adjusting system of the present invention is characterized in that, the controlling device calculates the slanted angle value between the location of the image capturing unit and the preset angle, and the slanted angle value can be displayed on the display device. The controlling device generates a controlling signal according to an angle value achieved by performing a plurality of calculations for the slanted angle value, and the motor is actuated according to the controlling signal from the controlling device to drive the gear mechanism and the image capturing unit to rotate to the preset position. The display signal or sound signal is generated for reminding the user that the image capturing device is adjusted to the preset position.

Consequently, the automatic angle adjusting system of the present invention can automatically adjust the image capturing device to the preset position with the preset function and the real-time balancing function. The preset angle can be 0° or other angle deviating from the horizontal line, so as to precisely locate the picture taken by the image capturing device to a horizontal balancing position. Thus even a beginner can shoot a precisely horizontal picture using the image capturing device with the automatic angle adjusting system. Therefore the drawbacks of complicated and time-consuming of editing a slanted picture in the prior art can be eliminated.

In addition, the angle detector can detect a momentary slanted angle value of the image capturing device, and immediately transmit the momentary slanted angle value for being displayed on the display device and being calculated by the controlling device that thus controls the driving device to drive the image capturing unit to the preset position.

Simultaneously, when the image capturing device is adjusted to the preset position, the automatic angle adjusting system can generate a display signal or sound signal to remind the user. Consequently, no matter for taking a static picture or a motion picture, the automatic angle adjusting system can achieve a balanced picture with intact main body and background preserved.

Furthermore, the automatic angle adjusting system of the present invention allows the user to define a preset angle value other than the 0° angle deviating from the horizontal line, thereby achieving a picture with image having the specific preset angle.

Conclusively, the automatic angle adjusting system of the present invention overcomes the drawbacks of the prior art and allows the image capturing device to freely control the image angle of a taken picture, and further can automatically adjust the image capturing unit to a preset horizontal or slanted angle to precisely locate the image to the preset position.

### BRIEF DESCRIPTION OF THE DRAWINGS

The present invention can be more fully understood by reading the following detailed description of the preferred embodiments, with reference made to the accompanying drawings, wherein:

FIGS. 1A-1C (PRIOR ART) are schematic diagrams of images taken by a conventional image capturing device;

FIG. 2 is a schematic block diagram of an automatic angle adjusting system according to a preferred embodiment of the present invention;

FIG. 3 is a perspective view of the automatic angle adjusting system according to the present invention;

FIG. 4 is a top view of an angle detector of the automatic angle adjusting system according to the present invention;

FIG. 5 is a partial cross-sectional view of the angle detector of FIG. 4;

FIG. 6 is a partial schematic diagram of the angle detector of FIG. 4;

FIG. 7 is a schematic view of metal pads of the automatic angle adjusting system according to the present invention;

FIG. 8 is a schematic block diagram of a controlling device of the automatic angle adjusting system according to the present invention;

FIG. 9 is a schematic diagram of a display device in the use of the automatic angle adjusting system according to the present invention;

FIG. 10 is a flowchart of operating the automatic angle adjusting system according to the present invention;

FIGS. 11A and 11B are schematic diagrams of operating statuses of an angle sensor of the automatic angle adjusting system according to the present invention;

FIG. 12 is another schematic diagram of the display device in the use of the automatic angle adjusting system according to the present invention;

FIG. 13 is a further schematic diagram of the display device in the use of the automatic angle adjusting system according to the present invention;

FIG. 14 is a schematic diagram of a captured image without the use of the automatic angle adjusting system;

FIG. 15 is a schematic diagram of a captured image in the use of the automatic angle adjusting system; and

FIG. 16 is another schematic diagram of a captured image in the use of the automatic angle adjusting system.

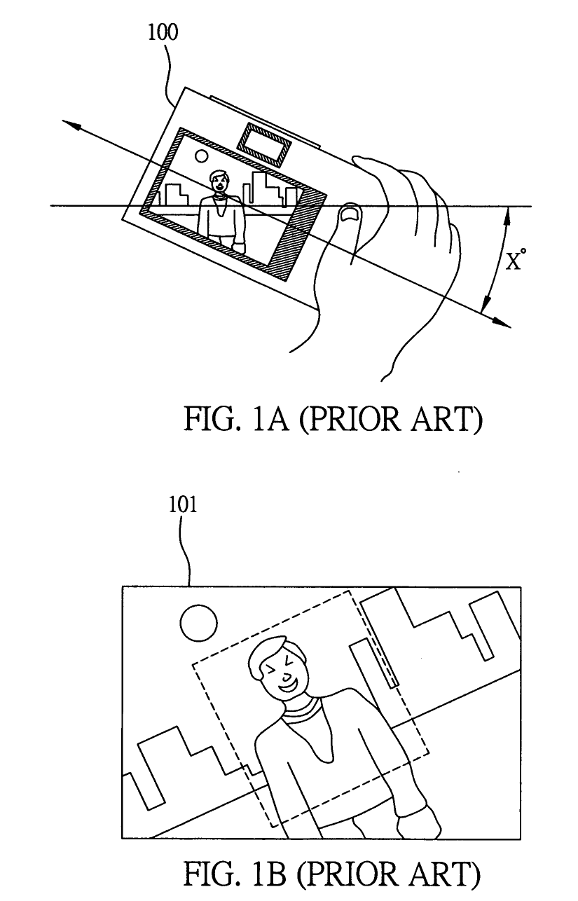

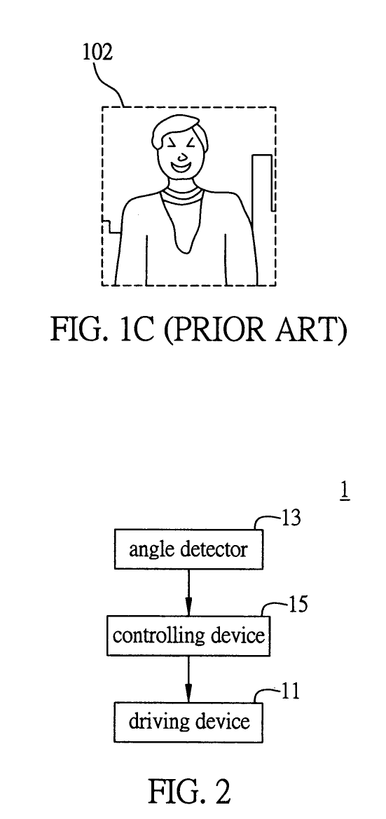

### DETAILED DESCRIPTION OF THE PREFERRED EMBODIMENTS

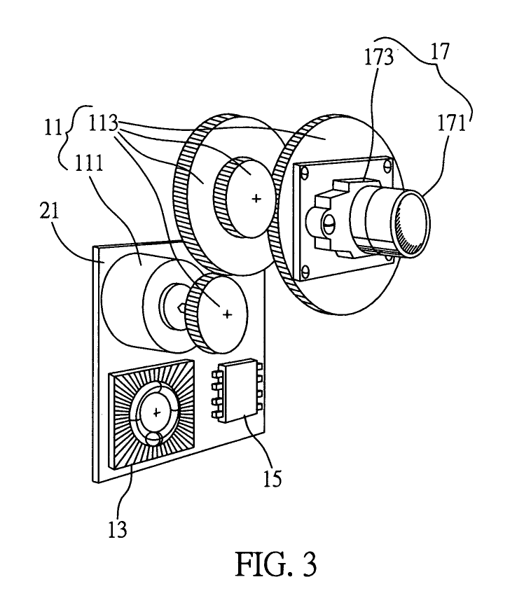

Referring to FIGS. 2 and 3, an automatic angle adjusting system 1 proposed in the present invention is suitably used in an image capturing device, so as to automatically control an oriented angle of a picture taken by an image capturing unit 17 of the image capturing device. The automatic angle adjusting system 1 comprises a driving device 11, an angle detector 13 and a controlling device 15, wherein the controlling status of the controlling device 15 can be displayed on a display device 19 of the image capturing device (detailed later).

The automatic angle adjusting system 1 can be employed in any conventional image capturing device such as digital camera, video camera or mobile phone whose structure is known. Thus only the part of structure of the image capturing device relating to the present invention is illustrated, for example, only lens 171 and sensor 173 of the image capturing unit 17 shown in FIG. 3. It should be understood that the location, shape and size of the components of the automatic angle adjusting system 1 are not limited to those shown in the drawings.

The driving device 11 is disposed on a circuit board 21 of the image capturing device, for driving the image capturing unit 17 to rotate to a preset angle to capture an image. The driving device 11 comprises a motor 111 and a gear mechanism 113. The preset angle is an angle between the horizontal line and an image to be taken by the image capturing device. The preset angle can be 0° parallel to the horizontal line, or any other specific angle. In this embodiment, the preset angle is 0°.

The motor 111 is mounted on the circuit board 21 and provides a mechanical driving force. The gear mechanism 113 is coupled to the motor 111. When the motor 111 rotates, the gear mechanism 113 is associatively driven to rotate to transfer the mechanical driving force. An input and output revolution ratio of the gear mechanism 113 is predetermined. The rotation direction and revolution of the motor 111 should be determined precisely according to the input and output revolution ratio; the technology for designing the rotation direction and speed of the motor 111 is conventional, thus not to be further detailed here.

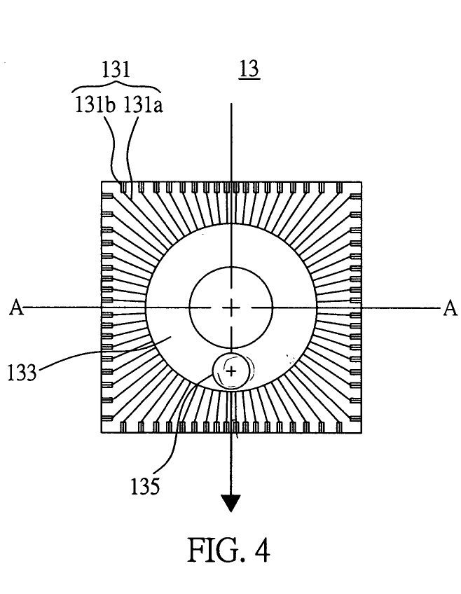

Referring to FIGS. 3 and 4, the angle detector 13 is mounted on the circuit board 21 of the image capturing device, for detecting a slanted angle between the image capturing device and the horizontal line. In this embodiment, the angel detector 13 serves as a horizon angle detector. The angle detector 13 comprises a conductive pattern board 131, a tunnel member 133 and a conductive element 135.

The conductive pattern board 131 comprises a plurality of conductive traces 131a and bond fingers 131b respectively coupled to the conductive traces 131a, for allowing the conductive traces 131a to be connected to other devices (not shown) via the bond fingers 131b, wherein the bond fingers 131b are preferably located close to edges of the conductive pattern board 131. The conductive pattern board 131 can be a double-side patterned board having the conductive traces 131a and bond fingers 131b formed on both sides of the conductive pattern board 131.

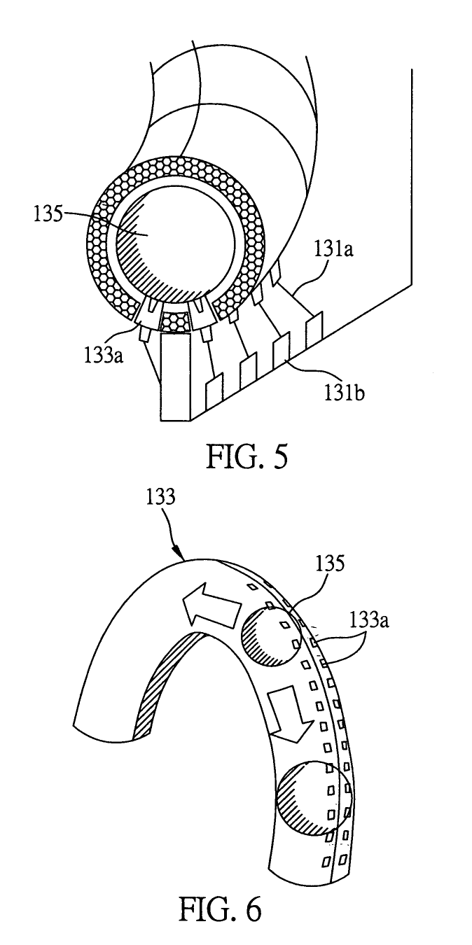

Referring to FIGS. 5 and 6, the tunnel member 133 is formed in the conductive pattern board 131 and can be an insulating ring-shaped pipe. The tunnel member 133 comprises a plurality of metal pads 133a respectively connected to the conductive traces 131a. The metal pads 133a are partly embedded in an inner wall of the tunnel member 133 and slightly protrude from the inner wall of the tunnel member 133. The metal pads 133a are arranged by two rows and a pair of metal pads 133a (one from each row) can serve as a switch. It is to be understood that the tunnel member 133 is not limited to the ring shape. For instance, for an image capturing device designed only for taking horizontal pictures, the tunnel member 133 can be an insulating semicircular pipe. That is, the shape of the tunnel member 133 can be flexibly modified according to different requirements.

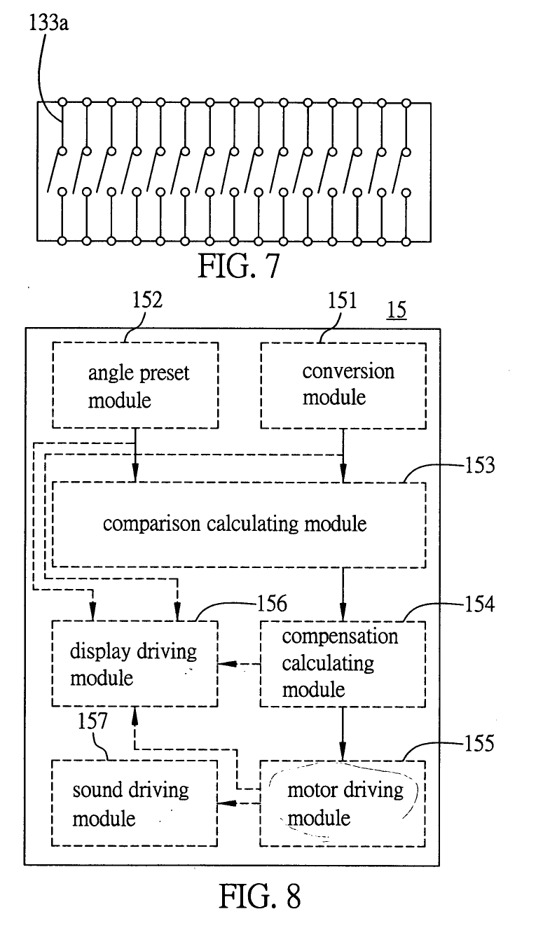

Referring to FIG. 7, each pair of the metal pads 133a serves as a tactile switch that is actuated by a metal ball and sends a position signal when the tactile switch is on. The metal pads 133a are arranged all around an outside surface of the tunnel member 133. The metal pads 133a can be spread over tunnel member 133 and evenly spaced at intervals of 10° angle (36 metal pads 133a), 5° angle (72 metal pads 133a), or 3° angle (120 metal pads 133a). The more the metal pads 133a, the smaller the distance between adjacent metal pads 133a is and the more precise the detected result is obtained.

The conductive element 135 such as metal ball is mounted and can freely roll within the tunnel member 133. When the conductive element 135 rolls within the tunnel member 133 and contacts one or more pairs of the metal pads 133a, the tactile switches of the one or more contacted pairs of metal pads 133a are electrically actuated to be on and respectively output a position signal. In this embodiment, only one conductive element 135 is used; however, two or more conductive rollers 135 can also be employed according to different requirements.

Referring further to FIG. 4, when the angle detector 13 is positioned perpendicularly to the horizontal line AA and the ground, the conductive element 135 rolls downwardly and stops at a bottom point of the tunnel member 133 due to gravity indicated by the arrow in FIG. 4, and electrically actuates the pair of metal pads 133a at the bottom point to be on.

Therefore, in the case of the angle detector 13 rotated clockwise or counterclockwise by an angle with respect to the horizontal line AA, the conductive element 135 would roll within the tunnel member 133 and contact the pairs of metal pads 133a located on the path of rolling of the conductive element 135, and finally stops at the pair of metal pads 133a at the bottom point of the tunnel member 133 due to gravity. The contacted pairs of metal pads 133a are electrically actuated and respectively send a position signal to the controlling device 15 that calculates the angle value between the angle detector 13 and the horizontal line AA according to the position signals from the actuated metal pads 133a (detailed later).

Referring to FIG. 8, a user can input or select a preset angle value in the controlling device 15 mounted to the circuit board 21. The controlling device 15, such as microprocessor, is used to receive the position signal from the actuated pairs of metal pads 133a of the angle detector 13. The controlling device 15 comprises a conversion module 151, an angle preset module 152, a comparison calculating module 153, a compensation calculating module 154, a motor driving module 155 and a display driving module 156.

The conversion module 151 is used for receiving the position signals from the pairs of metal pads 133a, and for calculating and obtaining the value of angle (“slanted angle value” hereinafter) between the position of the angle detector 13 and the horizontal line.

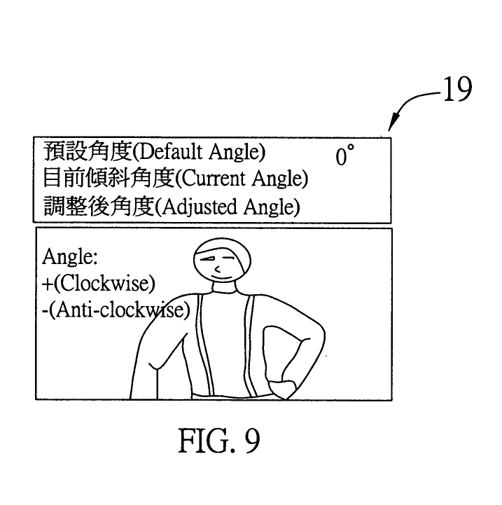

The angle preset module 152 allows a preset angle value to be inputted and stored thereto, wherein the preset angle is a desired angle between the horizontal line and a picture taken by the user using the image capturing device. Referring to FIG. 9, if the user intends to keep the picture to be horizontal, the preset angle can be 0°.

In another aspect, if the user prefers the picture slanted by an angle with reference to the horizontal line, an input interface (not shown) can be employed to input different preset angle values to the angle preset module 152 where the input preset angle values are stored. In other words, the preset angle can be any angle besides 0°, such that the user can use the automatic angle adjusting system 1 to automatically control the shooting angle of the image capturing device to obtain a picture slanted by a desired angle.

The comparison calculating module 153 is used to compare and calculate the difference between the slanted angle value from the conversion module 151 and the preset angle value. For example, if the preset angle is 0°, and the slanted angle is −35° (counterclockwise), the angle of difference is −35°; if the preset angle is +20° (clockwise), and the slanted angle is −35° (counterclockwise), the angle of difference is −15°; it should be noted that the positive angle represents a clockwise angle, and the negative angle represents a counterclockwise angle.

The compensation calculating module 154 is used to receive the value of angle of difference from the comparison calculating module 153, and calculate a compensation angle value which is a reverse value of the value of angle of difference. For example, if the angle of difference is counterclockwise −35°, the compensation angle is clockwise +35°, such that the driving device 11 is driven to rotate by 35° clockwise (detailed later) to resume the preset angle.

The motor driving module 155 is used to receive the compensation angle value from the compensation calculating module 154, and determine the rotation direction and rotation turns of the driving device 11 according to the compensation angle value, as well as transmit a command of the rotation direction and rotation turns to the driving device 11. When the driving device 11 is driven by the motor driving module 155 to complete the rotation turns in the rotation direction, the display driving module 156 receives and processes a rotation complete signal from the motor driving module 155. The display driving module 156 can also receive and process the slanted angle value from the conversion module 151, the preset angle value from the angle preset module 152, and the compensation angle value from the compensation calculating module 154.

Referring to FIG. 8, the controlling device 15 can further comprise a sound driving module 157. The sound driving module 157 is used to receive the rotation complete signal from the motor driving module 155, and processes and transmits the rotation complete signal to the display device 19 or a sound device (not shown), so as to generate a display signal or a sound signal to notify the user that the present angle is achieved by the image capturing device and shooting is readily performed. It should be understood that, besides the display or sound signal, the sound driving module 157 can also generate other types of signals, such as flashing light, to catch the user's attention.

In this embodiment, the image capturing unit 17 is mounted on the driving device 11, for receiving the mechanical driving force from the driving device 11 to rotate to an angle (i.e. preset angle) for capturing an image. As shown in FIG. 3, the image capturing unit 17 is coupled to the gear mechanism 113 of the driving device 11. The rotation direction and angle of the image capturing unit 17 are controlled by the motor 111 and the gear mechanism 113. The image capturing unit 17 comprises a lens 171 and a sensor 173.

Light through the lens 171 can reach the sensor 173. The sensor 173 can be a charge coupled device (CCD) or a complementary metal-oxide semiconductor (CMOS). The image capturing device may further comprise a built-in intelligent controlling device (not shown) to analyze and process the light, and automatically adjust parameters of focus, time of exposure, chroma and white balance, and then transmit these data of captured image to an analog digital converter (ADC) for converting the electronic analog signals into digital signals. The configuration, specification and controlling means for the lens 171 and sensor 173 are known in the art, thus not to be further detailed here.

The display device 19 can receive the processed slanted angle value, preset angle vale, compensation angle value and rotation complete signal from the display driving module 156, and display the current slanted status of the image capturing device thereon. The display device 19 can be disposed on any position of the circuit board 21 or the image capturing device as long as it can receive the above values and signal to inform the user of the current status of the image capturing device. The location the display device 19 may be further flexibly arranged according to different requirements.

Consequently, no matter whether the image capturing device held by the user complies with the preset angle, the angle detector 13 can immediately detect the current angle of the image capturing device, allowing the image capturing unit 17 to be driven to rotate clockwise or counterclockwise to the preset angle to achieve the desired picture.

Further, the driving device 11, angle detector 13 and controlling device 15 can all manufactured by small scale components and thus would not dramatically increase the volume and weight of the image capturing device. The automatic angle adjusting system 1 mounted in the image capturing device provides the automatic angle adjusting function, and allows a beginner to easily take a desired picture using the image capturing device, without wasting time and requiring extra software and equipment for adjusting the captured image using conventional image capturing devices.

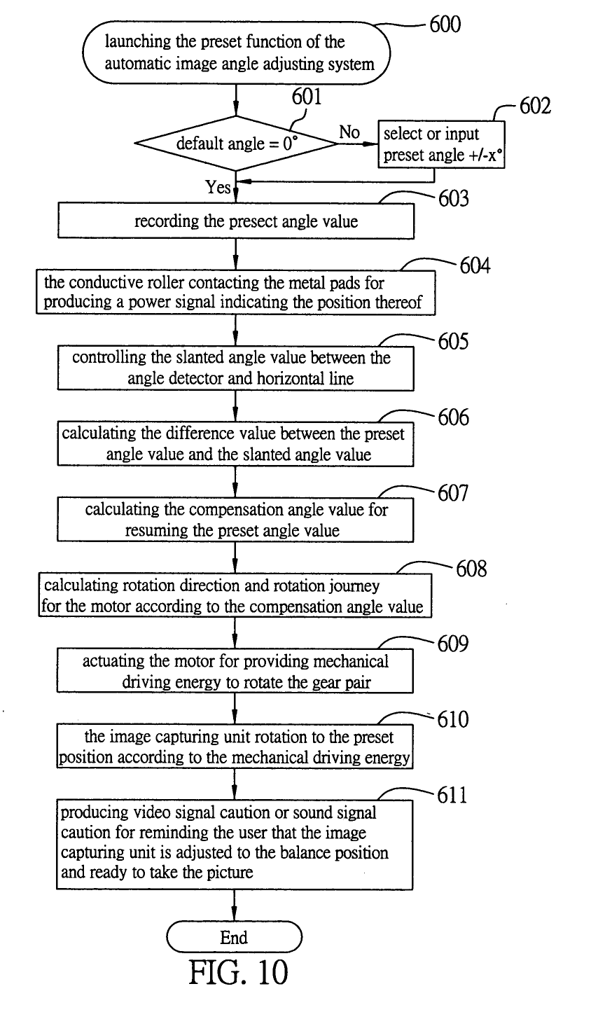

When the user uses the image capturing device with the automatic angle adjusting system 1 to take a picture, the operation steps are shown in FIG. 10. First in step 600, the preset function of the automatic angle adjusting system 1 is launched. The preset function can be variably specified during the manufacture of the system 1 according to different requirement.

In step 601, the user can select a preset angle value or input the preset angle value via an input interface. If the preset angle is 0°, the display device 19 shows a display picture in FIG. 9. The default preset angle is 0°; otherwise, in step 602, the user is allowed to select or input another preset angle e.g. ±x° (+x° represents a clockwise angle, and −x° represents a counterclockwise angle).

In step 603, the angle preset module 152 of the controlling device 15 records the preset angle value and transmits the preset angle value to the display driving module 156. The display driving module 156 converts the preset angle value into a display parameter, and transmits the display parameter to the display device 19.

In step 604, the automatic angle adjusting system 1 performs a real-time balancing procedure. The conductive element 135 of the angle detector 13 contacts the pairs of metal pads 133a of the tunnel member 133, making the pairs of metal pads 133a electrically actuated and generate position signals corresponding to the positions of the actuated metal pads 133a. In this embodiment of the present invention, the conductive element 135 can be a metal ball, which always rolls and stops at a bottom position of the tunnel member 133 due to gravity.

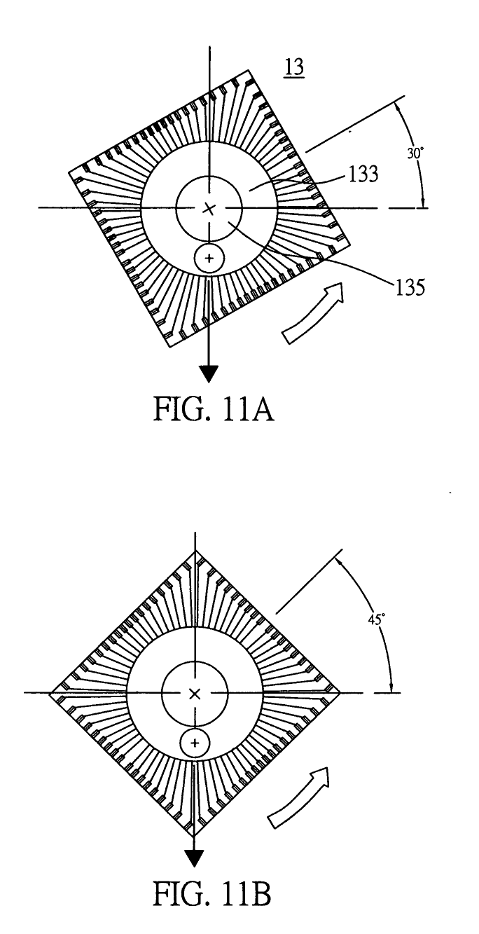

In the case that the user does not horizontally hold the image capturing device, for example, as shown in FIG. 11A, making the angle detector 13 deviating counterclockwise from the horizontal line by a 30° angle, the conductive element 135 would roll clockwise from A position to the bottom position of the tunnel member 133 and contact the pairs of metal pads 133 located on the rolling path of the conductive element 135 making these pairs of metal pads 133a electrically actuated and generate their position signals. As shown in FIG. 11B, when the angle detector 13 more deviates from the horizontal line by a 45° angle, the conductive element 135 rolls and contacts more pairs of metal pads 133a, and also stops at the bottom position of the tunnel member 133 due to gravity. The more contacted metal pads 133a are actuated and generate more position signals.

Consequently, no matter what an angle of deviation between the angle detector 13 and the horizontal line, the position signals from the pairs of metal pads 133a actuated by rolling of the conductive element 135 within the tunnel member 133 are transmitted to the controlling device 15 for obtaining the angle of deviation (hereinafter “slanted angle”).

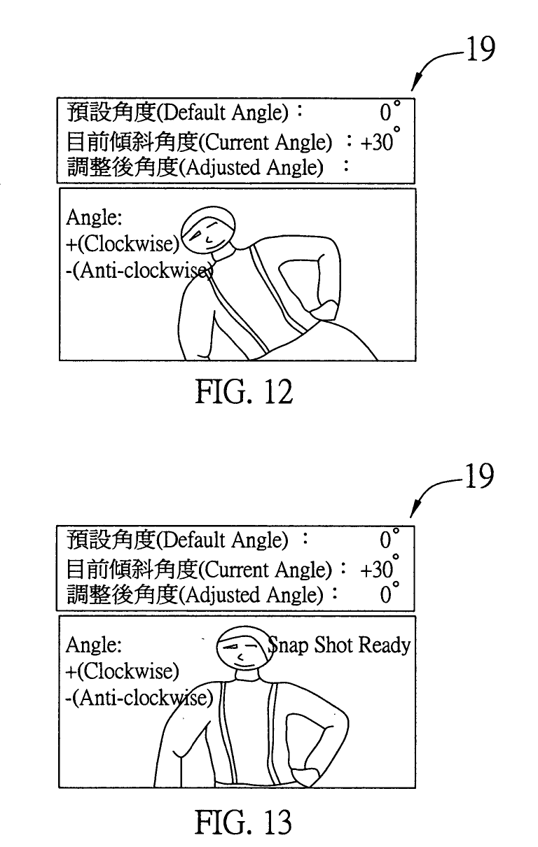

In step 605, according to the transmitted position signals from the metal pads 133a, the conversion module 151 of the controlling device 15 calculates a value of the slanted angle between the angle detector 13 and the horizontal line, and transmits the slanted angle value to the display driving module 156. Then, the display driving module 156 transmits a signal to the display device 19 where the calculated slanted angle value is displayed, as shown in FIG. 12, for example, the current slanted angle +30°.

In step 606, the comparison calculating module 153 of the controlling device 15 calculates the difference between the preset angle value and the slanted angle value; for example, if the preset angle is 0° and the slanted angle is −35°, the calculated angle of difference value is −35°.

In step 607, the compensation calculating module 154 of the controlling device 15 receives the difference between the preset angle value and the slanted angle value from the comparison calculating module 153, and calculates a compensation angle value which is a reverse value of the angle value of difference. The compensation angle value is used to resume the preset angle value. For example, if the angle of difference is −35°, the calculated compensation angle is thus made +35°.

In step 608, the motor driving module 155 of the controlling device 15 receives the compensation angle value from the compensation calculating module 154, and calculates a rotation direction and rotation turns for the motor 111 of the driving device 11 according to the compensation angle value, as well as transmits a signal for actuating the angle compensation process.

In step 609, the driving device 11 receives the signal for actuating the angle compensation process from the motor driving module 155, and actuates the motor 111 to rotate according to the rotation direction and rotation turns and provide a mechanical driving force to rotate the gear mechanism 113.

In step 610, the image capturing unit 17 in turn receives the mechanical driving force from the gear mechanism 113, and accordingly rotates to a predetermined position. Consequently, no matter what an angle deviating from the horizontal line the angle detector 13 clockwise or counterclockwise rotated, the image capturing unit 17 can be counterclockwise or clockwise driven to compensate the rotation of the angle detector 13 and resume the preset angle, thereby achieving the desired picture with a horizontal image or an image with a specific angle deviating from the horizontal line for the user.

In step 611, when the motor 111 completes the rotation turns, the display driving module 156 of the controlling device 15 receives and processes a rotation complete signal from the motor driving module 155, and transmits the processed rotation complete signal to the display device 19 where the processed signal is displayed; for example, as shown in FIG. 13, “Snap Shot Ready” is displayed on the display device 19. It should be understood that the processed rotation complete signal displayed on the display device 19 is not limited to a text signal, and other types of signals such as flashing light or sound signal are also suitably used.

The rotation complete signal can be further transmitted to the sound driving module 157. The sound driving module 157 converts the rotation complete signal into a sound signal, and transmits the sound signal to the display device 19 or a sound device (not shown) where a caution sound is generated for informing the user that the image capturing device reaches the desired balance position ready for shot.

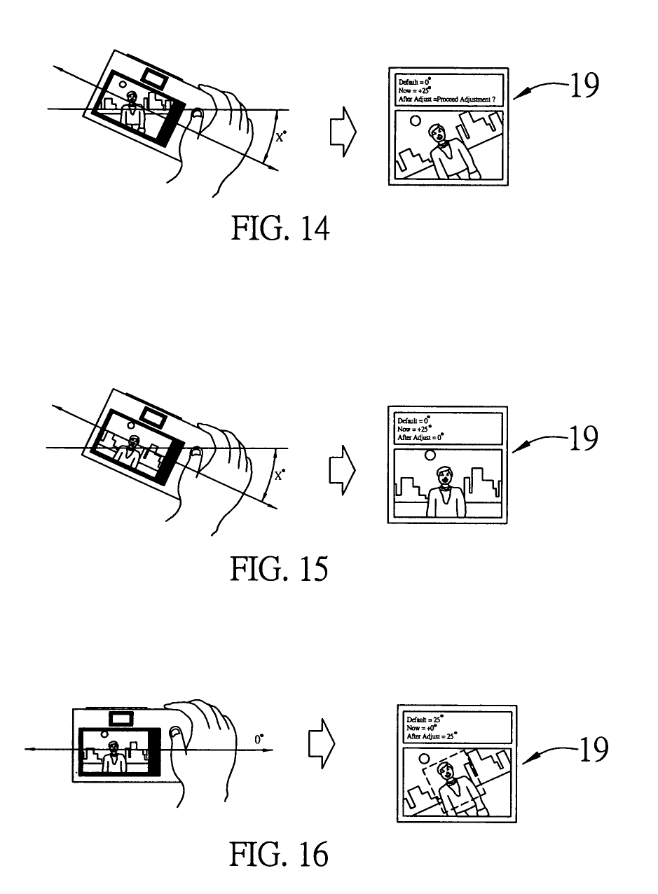

Referring to FIG. 14, when the user holds the image capturing device with a slanted angle deviating from the horizontal line, the display device 19 of the image capturing device first displays an image slanted by the angle, and then the above steps are followed to actuate the automatic angle adjusting system 1 to adjust the displayed image according to a preset angle. Referring to FIG. 15, if the preset angle is 0°, the displayed image adjusted by the automatic angle adjusting system 1 becomes parallel to the horizontal line.

If the user intends to have the image with a specific angle deviating from horizontal line, the user can select or input the specific angle as the preset angle to the actuated automatic angle adjusting system 1 to achieve the desired image. For example, referring to FIG. 16, when the preset angle is set as clockwise 25°, no matter what an angle the image capturing device is held deviating from the horizontal line, the automatic angle adjusting system 1 can adjust the image to have the clockwise 25° angle.

Furthermore, when taking a motion picture, even if the lens 171 of the image capturing device is moving in accordance with the moving object, the automatic angle adjusting system 1 can real-time adjust the image according to the preset angle to achieve a precisely positioned and balanced picture.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. An automatic angle adjusting system for an image capturing device, the image capturing device having an image capturing unit for capturing an image, the automatic angle adjusting system comprising:
a driving device for providing the image capturing unit with a mechanical driving force that drives the image capturing unit to rotate to a preset angle to capture the image;
an angle detector for detecting the location of the image capturing unit; and
a controlling device for storing the preset angle value and calculating an angle of the location of the image capturing unit deviating from the preset angle to transmit a signal to the driving device that drives the image capturing unit to rotate to compensate the deviated angle and resume the preset angle.

2. The automatic angle adjusting system as claimed in claim 1, wherein the preset angle is an angle of the image to be captured deviating from a horizontal line.

3. The automatic angle adjusting system as claimed in claim 2, wherein the preset angle is 0° parallel to the horizontal line.

4. The automatic angle adjusting system as claimed in claim 2, wherein the preset angle is an angle other than 0°.

5. The automatic angle adjusting system as claimed in claim 1, further comprising a display device for receiving a signal from the controlling device to display a shooting status of the image capturing device.

6. The automatic angle adjusting system as claimed in claim 1, further comprising a display device for receiving a signal from the controlling device to display a light signal indicating that the image capturing unit is adjusted to a preset balance position.

7. The automatic angle adjusting system as claimed in claim 1, further comprising a sound device for receiving a signal from the controlling device to generate a sound signal indicating that the image capturing unit is adjusted to a preset balance position.

8. The automatic angle adjusting system as claimed in claim 1, wherein the driving device comprises a motor and a gear mechanism connected to the motor.

9. The automatic angle adjusting system as claimed in claim 1, wherein the angle detector is a horizon angle detector.

10. The automatic angle adjusting system as claimed in claim 1, wherein the angle detector comprises a conductive pattern board, a tunnel member formed in the conductive pattern board, and at least one conductive element rotatably mounted in the tunnel member.

11. The automatic angle adjusting system as claimed in claim 10, wherein the tunnel member comprises a plurality of metal pads.

12. The automatic angle adjusting system as claimed in claim 11, wherein the metal pads are partly embedded in an inner wall of the tunnel member and serve as switches.

13. The automatic angle adjusting system as claimed in claim 11, wherein the metal pads are arranged in two rows, and at least one pair of the metal pads each from one of the rows form a tactile switch that is capable of being electrically actuated to generate a position signal indicating a position of the pair of metal pads.

14. The automatic angle adjusting system as claimed in claim 1, wherein the controlling device is a microprocessor.

15. The automatic angle adjusting system as claimed in claim 11, wherein the controlling device comprises a conversion module, an angle preset module, a comparison calculating module, a compensation calculating module, a motor driving -module and a display driving module; the conversion module for receiving position signals from the electrically actuated metal pads of the tunnel member to obtain the location of the image capturing unit and for calculating the angle of the location of the image capturing unit deviating from a horizontal line; the angle preset module for inputting and storing the present angle value; the comparison calculating module for receiving the deviated angle value from the conversion module and the preset angle value from the angle preset module to calculate an angle of difference between the preset angle and the deviated angle; the compensation calculating module for receiving the angle value of difference from the comparison calculating module and calculating a reverse compensation angle for resuming the preset angle; the motor driving module for receiving the reverse compensation angle value and for calculating a rotation direction and rotation turns for the driving device to resume the preset angle and generating a signal indicating the rotation direction and rotation turns; and the display driving module for receiving the deviated angle value from the conversion module, the preset angle value from the angle preset module and the reverse compensation angle value from the compensation calculating module, and converting these angles into parameters, and for receiving a rotation complete signal from the motor driving module.

16. The automatic angle adjusting system as claimed in claim 1, wherein the preset angle is inputted via an input interface.

17. The automatic angle adjusting system as claimed in claim 15, wherein the controlling device further comprises a sound driving module for receiving the rotation complete signal from the motor driving module.

18. The automatic angle adjusting system as claimed in claim 17, wherein the rotation complete signal is processed and transmitted by the controlling device to a display device where a display signal or sound signal is displayed when the image capturing unit is adjusted to a preset position.

19. The automatic angle adjusting system as claimed in claim 17, wherein the rotation complete signal is processed and transmitted by the controlling device to a sound device where a sound signal is generated when the image capturing unit is adjusted to a preset position.

20. The automatic angle adjusting system as claimed in claim 18, wherein the display signal is a text signal.
